(19) United States
(12) Patent Application Publication
(10) Pub. No.: US 2026/0154890 A1
(43) Pub. Date: Jun. 4, 2026

(54) ARTIFICIAL INTELLIGENCE DEVICE FOR CREATING ANIMATABLE 4D PORTRAIT AVATARS WITH MORPHABLE MULTI-VIEW DIFFUSION MODELS AND METHOD THEREOF

(71) Applicants: LG ELECTRONICS INC., Seoul (KR); The Governing Council of the University of Toronto, Toronto (CA)

(72) Inventors: Felix TAUBNER, Toronto (CA); Mathieu TULI, Toronto (CA); David Brian LINDELL, Toronto (CA)

(73) Assignees: LG ELECTRONICS INC., Seoul (KR); The Governing Council of the University of Toronto, Toronto, ON (CA)

(21) Appl. No.: 19/404,896

(22) Filed: Dec. 1, 2025

Related U.S. Application Data
(60) Provisional application No. 63/726,638, filed on Dec. 1, 2024.

(51) Int. Cl. G06T 13/40; G06T 15/04; G06T 15/08; G06T 15/20; G06T 17/20

(52) U.S. Cl. CPC G06T 13/40; G06T 15/04; G06T 15/08; G06T 15/20; G06T 17/205

(57) ABSTRACT

A method for controlling an artificial intelligence (AI) device can include receiving a set of reference images of a subject and encoding them into reference latents. The method estimates 3D morphable model (3DMM) parameters to derive pose and expression conditioning signals. A plurality of synthetic images are generated from different viewpoints using a morphable multi-view diffusion model. Generating the synthetic images includes executing an iterative reverse diffusion process on generated latents and applying stochastic conditioning by randomly sampling a subset of the reference latents and a subset of the generated latents to condition the model. The method further includes decoding the generated latents and training a 4D avatar model based on the reference and synthetic images. The 4D avatar model can utilize 3D Gaussian splatting augmented with expression-dependent appearance model information to enable real-time animation.

### CROSS-REFERENCE TO RELATED APPLICATIONS

This non-provisional application claims priority under 35 U.S.C. § 119(e) to U.S. Provisional Application No. 63/726,638, filed on Dec. 1, 2024, the entirety of which is hereby expressly incorporated by reference into the present application.

### BACKGROUND

### Field

The present disclosure relates to a device and method for generating animatable four-dimensional (4D) avatars (e.g., 3D and dynamic or animatable) from a set of reference images, in the field of artificial intelligence (AI). Particularly, the method can utilize a morphable multi-view diffusion model with stochastic conditioning to synthesize consistent novel views for training a real-time 4D avatar model based on 3D Gaussian splatting augmented with an expression dependent appearance model.

### Discussion of the Related Art

Artificial intelligence (AI) has driven significant progress in the fields of computer vision and computer graphics, particularly in the creation of photorealistic digital avatars. The ability to reconstruct and animate three-dimensional (3D) heads from two-dimensional (2D) images is increasingly desirable for applications ranging from telepresence and virtual reality (VR) to film production and immersive gaming.

However, existing methods for creating 4D (dynamic 3D) avatars face significant tradeoffs between accessibility and quality. High fidelity approaches typically rely on complex, multi-view camera rigs and controlled studio environments to capture geometric and texture data. While these setups can produce high quality results, the requirement for expensive, specialized hardware often makes them impractical.

Also, methods designed for monocular (e.g., single camera) or few shot inputs often suffer from issues with consistency and scalability. For example, recent generative diffusion models frequently struggle to maintain multi-view consistency and identity preservation across different angles and expressions. For example, when scaling these models to process varying numbers of input images, they often fail to effectively aggregate information, leading to artifacts or inconsistencies, or the generation of conflicting geometric features that degrade the realism of the final animation (e.g., a person's shirt or color may randomly change, details such as moles may randomly appear or disappear, etc.).

Further, the computational complexity of existing rendering techniques hinders their deployment on standard devices or edges devices. Many existing reconstruction methods require significant processing power and long inference times to render dynamic scenes. These computational demands often preclude real-time performance on consumer hardware, such as mobile phones or tablets, which limits the utility of 4D avatars in interactive, real-time communications.

Thus, a need exists for an improved method and device that can robustly generate animatable 4D avatars from a number of reference images, ranging from a single image to a large collection of photos. For example, a framework is needed that can flexibly scale to process unconstrained input data without requiring complex multi-camera rigs or controlled studio environments.

Further, a need exists for a generative mechanism that can synthesize novel viewpoints of a subject while strictly preserving identity and consistency across all generated frames. A solution is needed that can generate dense 3D reconstructions from limited inputs, effectively synthesizing missing details while preserving the subject's identity.

Also, a need exists for a comprehensive training and rendering pipeline that can produce high-fidelity, expression dependent 4D avatars that capture fine details, such as hair strands and skin texture, while remaining capable of being animated and rendered in real-time even on standard consumer hardware or edge devices.

### SUMMARY OF THE DISCLOSURE

The present disclosure has been made in view of the above problems and it is an object of the present disclosure to provide a device and method capable of generating photorealistic, animatable 4D avatars from a variable number of reference images, in the field of artificial intelligence (AI). Further, the method can utilize a morphable multi-view diffusion model with stochastic conditioning to synthesize consistent novel views, enabling the training of a real-time, expression-dependent 4D avatar model.

An object of the present disclosure is to provide an artificial intelligence (AI) device and method for generating animatable 4D avatars from a set of reference images. The method can utilize a comprehensive framework that combines a generative diffusion process with a real-time rendering representation to synthesize consistent data and reconstruct high fidelity avatars. For example, the method can employ a morphable multi-view diffusion model to synthesize a diverse set of novel view images of a subject from the set of reference images, which can be one image or many images. Also, to ensure multi-view consistency and identity preservation across these generated images, the diffusion model can utilize stochastic conditioning, in which the model randomly samples subsets of reference latents and generated latents during an iterative reverse diffusion process. These consistently generated images can then serve as training data for a 4D avatar model. According to an embodiment, this 4D avatar model can utilize 3D Gaussian splatting initialized from a parametric mesh and augmented with an expression dependent appearance model. For example, this configuration can allow the 4D avatar to dynamically adjust Gaussian properties based on expression coefficients, thereby enabling the real-time rendering of photorealistic, animatable avatars with high frequency details, even when the initial input is limited to just one or a few photographs of the subject.

Another object of the present disclosure is to provide a method for controlling an artificial intelligence (AI) device that can include receiving, by a processor of the AI device, a set of reference images of a subject, wherein the set of reference images includes one or more images, encoding, by the processor, the set of reference images into a set of reference latents, estimating, by the processor, 3D morphable model (3DMM) parameters for the set of reference images, deriving, by the processor, pose and expression conditioning signals based on the 3DMM parameters, generating, by the processor, a plurality of synthetic images of the subject from different viewpoints based on the pose and expression conditioning signals using a morphable multi-view diffusion model, in which the generating the plurality of synthetic images includes executing an iterative reverse diffusion process on a set of generated latents, applying stochastic conditioning during steps of the iterative reverse diffusion process by randomly sampling a subset of the set of reference latents and a subset of the set of generated latents to condition the morphable multi-view diffusion model, and decoding the set of generated latents to produce the plurality of synthetic images, and training, by the processor, a 4D avatar model based on the set of reference images and the plurality of synthetic images to generate a trained 4D avatar model, wherein the 4D avatar model utilizes 3D Gaussian splatting augmented with expression dependent appearance model information.

It is another object of the present disclosure to provide a method that includes animating, by the trained 4D avatar model, a 4D avatar corresponding to the subject.

Yet another object of the present disclosure is to provide a method, in which the deriving pose and expression conditioning signals includes generating, for each image in the set of reference images and for each synthetic image to be generated, a set of conditioning maps including one or more of a view direction map encoding camera ray directions, a 3D pose map representing rasterized vertex positions of a template mesh, and an expression deformation map representing rasterized vertex deformations relative to a neutral expression mesh.

An object of the present disclosure is to provide a method, in which the applying stochastic conditioning includes randomly selecting different subsets of the set of reference latents to condition different groupings of the set of generated latents during the iterative reverse diffusion process.

Another object of the present disclosure is to provide a method, in which the morphable multi-view diffusion model includes a U-Net architecture including 3D attention layers configured to perform attention to correlate features between the subset of the set of reference latents and the subset of the set of generated latents.

An object of the present disclosure is to provide a method, in which the stochastic conditioning enables the morphable multi-view diffusion model to generate consistent synthetic images regardless of a number of images in the set of reference images.

Yet another object of the present disclosure is to provide a method, in which the 4D avatar model includes a plurality of 3D Gaussian primitives, and the training the 4D avatar model includes initializing the plurality of 3D Gaussian primitives by attaching each 3D Gaussian primitive to a specific parent triangle of a parametric mesh derived from the 3DMM parameters.

An object of the present disclosure is to provide a method, in which the expression dependent appearance information is generated by an expression dependent appearance model that includes a neural network configured to receive expression coefficients associated with the subject and dynamically modulate color properties or coefficients of the plurality of 3D Gaussian primitives based on the expression coefficients.

Another object of the present disclosure is to provide a method, in which the training the 4D avatar model further includes remeshing the parametric mesh to obtain pixel-aligned vertices in a UV space, converting expression parameters into a UV map representation, and utilizing a deformation network to predict a UV deformation map based on the UV map representation to correct or augment facial deformations.

An object of the present disclosure is to provide a method, in which the training the 4D avatar model includes optimizing parameters of the 3D Gaussian splatting by minimizing a loss function that compares a rendered image of the 4D avatar model against a corresponding image from the set of reference images or the plurality of synthetic images.

It is another object of the present disclosure to provide a method that includes animating, by the trained 4D avatar model, a 4D avatar corresponding to the subject in real-time by rendering the 4D avatar model on a mobile device by updating the expression dependent appearance model information based on a driving signal while maintaining a static set of canonical Gaussian parameters.

Another object of the present disclosure is to provide an artificial intelligence (AI) device including a memory configured to store information for a morphable multi-view diffusion model, and a controller configured to receive a set of reference images of a subject, wherein the set of reference images includes one or more images, encode the set of reference images into a set of reference latents, estimate 3D morphable model (3DMM) parameters for the set of reference images, derive pose and expression conditioning signals based on the 3DMM parameters, generate a plurality of synthetic images of the subject from different viewpoints based on the pose and expression conditioning signals using the morphable multi-view diffusion model, in which generating the plurality of synthetic images includes executing an iterative reverse diffusion process on a set of generated latents, applying stochastic conditioning during steps of the iterative reverse diffusion process by randomly sampling a subset of the set of reference latents and a subset of the set of generated latents to condition the morphable multi-view diffusion model, and decoding the set of generated latents to produce the plurality of synthetic images, and train a 4D avatar model based on the set of reference images and the plurality of synthetic images to generate a trained 4D avatar model, wherein the 4D avatar model utilizes 3D Gaussian splatting augmented with expression dependent appearance model information.

An object of the present disclosure is to provide a non-transitory computer readable medium storing computer-executable instructions that when executed by a processor, cause the processor to perform the operations of receiving a set of reference images of a subject, wherein the set of reference images includes one or more images, encoding the set of reference images into a set of reference latents, estimating 3D morphable model (3DMM) parameters for the set of reference images, deriving pose and expression conditioning signals based on the 3DMM parameters, generating a plurality of synthetic images of the subject from different viewpoints based on the pose and expression conditioning signals using a morphable multi-view diffusion model, in which the generating the plurality of synthetic images includes executing an iterative reverse diffusion process on a set of generated latents, applying stochastic conditioning during steps of the iterative reverse diffusion process by randomly sampling a subset of the set of reference latents and a subset of the set of generated latents to condition the morphable multi-view diffusion model, and decoding the set of generated latents to produce the plurality of synthetic images, and training a 4D avatar model based on the set of reference images and the plurality of synthetic images to generate a trained 4D avatar model, wherein the 4D avatar model utilizes 3D Gaussian splatting augmented with expression dependent appearance model information.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4A is a block diagram illustrating the detailed components and data flow of the Stage 1 generative pipeline, according to an embodiment of the present disclosure.

FIG. 4B is a block diagram illustrating the Stage 2 reconstruction pipeline, according to an embodiment of the present disclosure.

FIG. 5 illustrates an example flow chart for a method of controlling an AI device according to an embodiment of the present disclosure.

FIG. 6 is a flowchart illustrating an example overview of the CAP4D framework, according to an embodiment of the present disclosure.

FIG. 7 illustrates a detailed implementation of the Morphable Multi-View Diffusion Model (MMDM) processing a specific batch of data, according to an embodiment of the present disclosure.

FIG. 8 illustrates MMDM conditioning and preprocessing each reference image based on the estimated 3DMM model, according to an embodiment of the present disclosure.

FIG. 9 illustrates an example of MMDM sampling, according to an embodiment of the present disclosure.

FIG. 10 illustrates an overview of the 4D avatar model according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

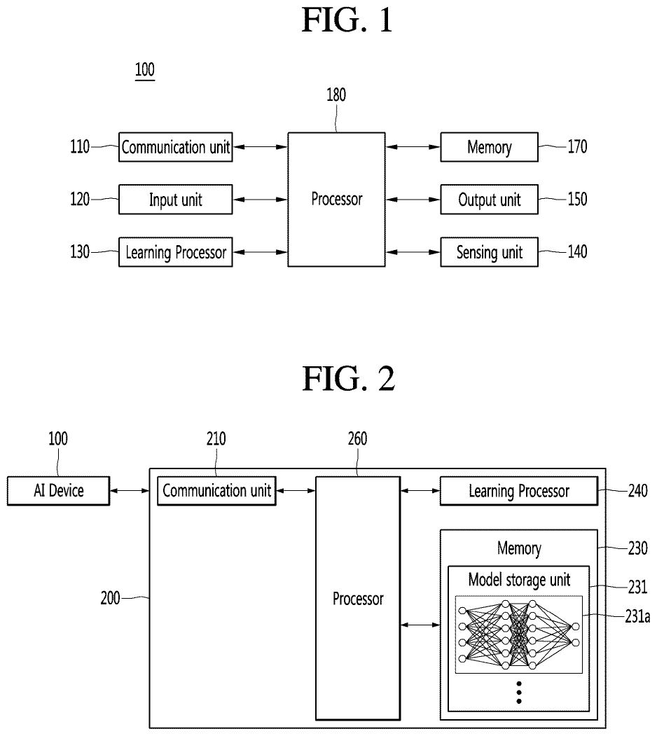

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

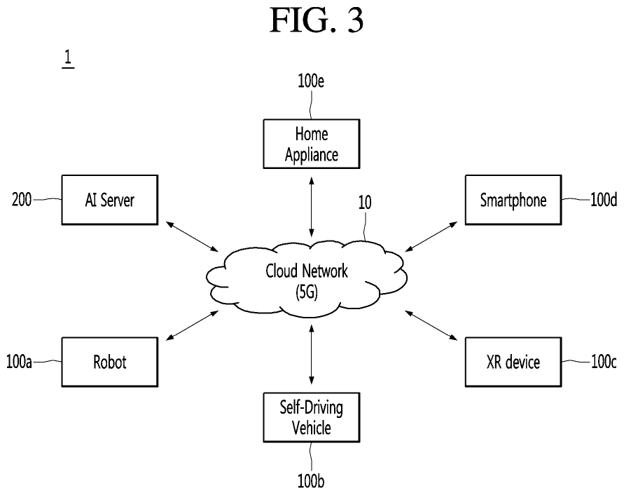

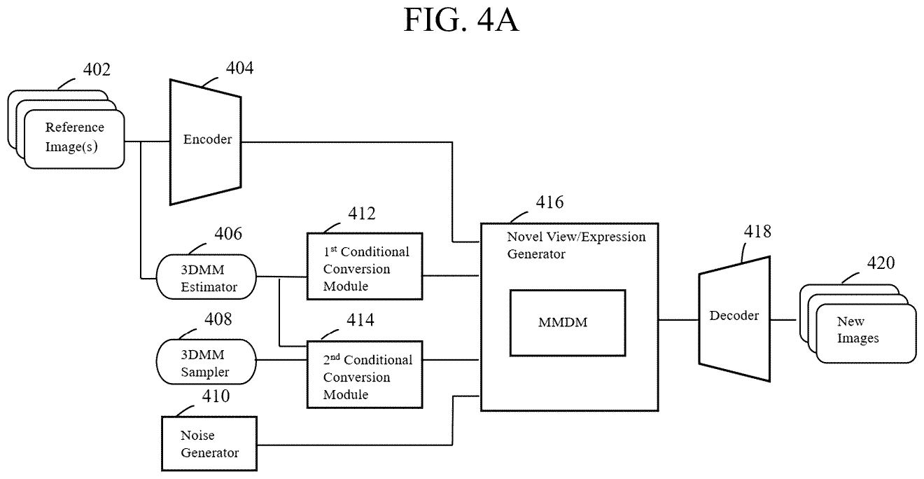

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data. For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device capable of displaying a 4D avatar, which can implement one or more of a large language model (LLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions via a 4D head avatar. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's personal preferences.

According to an embodiment, the AI device 100 can provide a method for generating animatable 4D avatars from a set of reference images by utilizing a morphable multi-view diffusion model with stochastic conditioning to synthesize consistent novel views and leveraging these views to train a real-time 4D avatar model to produce photorealistic, expression-dependent animations.

According to another embodiment, the AI device 100 can be integrated into an infotainment system of the self-driving vehicle 100b to provide a 4D avatar user experience, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and computer graphics, and more particularly, to methods and systems for synthesizing high-fidelity, animatable 4D avatars from varying amounts of visual data using generative diffusion models and neural rendering techniques.

For example, embodiments of the present disclosure can provide for a robust 4D avatar generation framework, which can be viewed as a foundational component for immersive applications requiring realistic digital humans, such as virtual reality (VR) telepresence, interactive gaming environments, film production, and personalized digital assistants.

As discussed above, the creation of photorealistic, animatable 4D avatars faces several technical challenges that limit their accessibility and fidelity in real-world applications. For example, a 4D avatar refers to a three-dimensional avatar that is extended to be animatable or dynamic (e.g., the 4^{th} “D”). Existing reconstruction methods typically demand a specific quantity and quality of input data, which creates a stark tradeoff between the ease of capture and the realism of the resulting avatar.

One significant challenge relates to the rigidity of current input requirements. For example, high end systems, such as those used in film production, often rely on elaborate multi-view capture rigs with dozens of synchronized cameras to acquire dense geometric and texture information. While these systems may produce exceptional results, the need for specialized hardware and controlled lighting makes them inaccessible to average users.

Conversely, methods designed for consumer applications often rely on single shot or few shot inputs, such as a simple selfie or a short video clip. However, these limited inputs lack the comprehensive visual data needed to fully reconstruct the 3D geometry and appearance of a head from all angles.

When dealing with such limited data, generative models can attempt to fill in the gaps, but they often struggle with consistency. For instance, a conventional diffusion model might generate a side view of a face based on a frontal photo, but the generated ear or jawline might not align properly with the original front view, or the person's clothes, colors or other features may abruptly change and then switch back. As the number of generated views increases, these inconsistencies accumulate, leading to “hallucinations” where the subject's identity drifts or artifacts may appear. This problem is exacerbated when scaling the input size, e.g., existing models are often designed for a fixed number of inputs (e.g., exactly 3 views) and cannot flexibly adapt to a variable set of reference images (e.g., 1, 5, 20, or 100 images) without requiring significant retraining or suffering performance degradation.

Another limitation of the existing art involves the representation and rendering of dynamic features. Traditional 3D morphable models (3DMMs) provide a structured way to represent faces but are often limited to a low-dimensional parameter space that fails to capture high-frequency details, such as wrinkles, hair strands, moles, or subtle skin texture changes during expressions.

On the other hand, neural radiance fields (NeRFs) can capture these fine details but are computationally heavy and expensive. Rendering a NeRF based avatar often requires querying a neural network millions of times per frame to determine color and density, which is prohibitively slow for real-time applications on mobile devices or other types of consumer edge devices.

Accordingly, a need exists for an improved method and system that can bridge these gaps. For example, a framework is needed that can robustly handle any given number of input images to generate consistent, novel views which can seamlessly scale, and subsequently use those views to train a lightweight, expression aware representation that supports real-time animation even on standard consumer hardware.

According to an embodiment, the AI device 100 can provide a scalable 4D avatar generation framework that overcomes the limitations of prior approaches by effectively bridging the gap between single or few shot generation and dense 3D reconstruction. For example, the method can utilize a two-stage pipeline that first leverages a generative diffusion model to synthesize consistent multi-view data from an arbitrary number of inputs, ranging from a single image to hundreds of images, and subsequently employs a neural rendering model to reconstruct a real-time, animatable avatar with high-frequency details.

For example, according to an embodiment, the framework can employ a morphable multi-view diffusion model equipped with stochastic conditioning to generate a comprehensive set of novel view images that maintain consistency across different poses and expressions. These generated images can then be used for training a 4D avatar model based on 3D Gaussian splatting, which can be further augmented with an expression dependent appearance model to enable the real-time rendering of dynamic facial animations, according to embodiments.

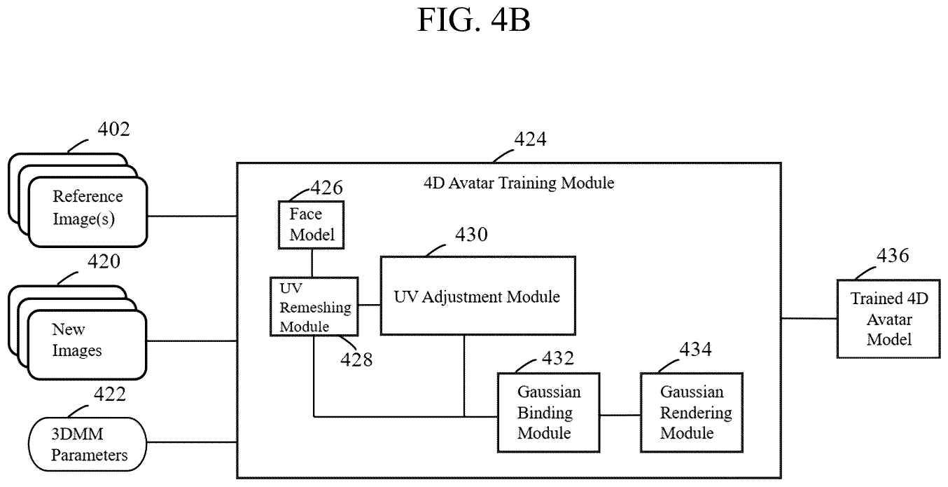

FIGS. 4A and 4B show an overview of Stage 1 and Stage 2 of the CAPD4 framework, according to embodiments.

For example, according to an embodiment, the overall architecture can be conceptualized as a two-stage framework designed to address the challenges of data scarcity and real-time rendering.

The first stage (e.g., Stage 1), can be referred to as a generative pipeline that can function as a type of data amplification engine. It can accept as input a variable number of input image(s) (e.g., ranging from a single image to a large collection of images) and leverages a diffusion based generative model to synthesize a dense, multi-view dataset.

For example, Stage 1 can ensure that the subsequent reconstruction phase for animating a 4D avatar model has sufficient ground truth data to resolve complex geometries and textures by bridging the gap between sparse input views and the comprehensive visual data for 3D modeling.

In this first stage, the system can employ a stochastic conditioning mechanism within a morphable multi-view diffusion model (e.g., MMDM). Rather than relying solely on the fixed reference images, the model can dynamically sample from both reference latents corresponding to the original reference image(s) and generated latents corresponding to new images to be generated during a denoising process. This can prevent hallucinations of inconsistent features that often seen in existing generative models. Consequently, the output is a set of synthetic images that depict the subject from novel angles and with novel expressions, all while maintaining strict consistency with the original subject.

The second stage can be referred to as a type of reconstruction pipeline which utilizes this synthesized dataset to train a lightweight, animatable 4D avatar model. Instead of using computationally heavy techniques, Stage 2 can utilize 3D Gaussian splatting initialized from a parametric mesh.

Further, in order to enable dynamic animation, the Gaussians are not static and they are augmented with an expression-dependent appearance model that modulates their properties based on expression coefficients. This can allow the final 4D avatar to be rendered in real-time, even on standard consumer hardware or edge devices while also providing high-frequency details (e.g., wrinkles, moles, detailed hair and subtle lighting changes) which correspond to the animated expressions.

In more detail, FIG. 4A is a block diagram illustrating the detailed components and data flow of the Stage 1 generative pipeline, according to an embodiment of the present disclosure.

As shown, the process can begin with the receipt of reference image(s) 402. These images serve as the ground truth input and can range in quantity from a single photograph to a large collection (e.g., five, twenty, or hundred images, etc.) of a subject's face. The goal of this stage is to amplify this initial input into a comprehensive dataset of synthetic images showing the subject from diverse angles and with varied expressions.

Further in this example, the reference image(s) 402 (e.g., I_{ref}) are processed along two parallel paths. In the first path, an encoder 404 (e.g., a Variational Autoencoder or VAE) receives the raw images as input. The encoder 404 can compress these images into a lower dimensional latent space representation (e.g., Z_{ref}). The output of the encoder 404 is a set of reference latents, which encode the main visual identity features of the subject in a compressed format suitable for efficient processing by the diffusion model (e.g., can be ⅛^{th} the data of the original image).

In the parallel path, a 3D morphable model (3DMM) estimator 406 can analyze the reference images 402 to extract explicit geometric and semantic information. For example, FlowFace estimator can be used according to an embodiment. However, embodiments are not limited thereto and other types of 3DMM estimators can be used.

According to an embodiment, then 3DMM estimator 406 can be based on a FLAME representation, which is discussed in more detail at a later section. However, embodiments are not limited thereto and other types of 3DMM implementations and models can be used.

Further in this example, the 3DMM estimator 406 can estimate a 3D head model for each image, decomposing the visual data into (a) head shape and facial structure (e.g., representing a neutral head), (b) expression offsets (e.g., deformations from the neutral head, such as smiling or frowning), and (c) camera information (e.g., viewing angle and focal length, etc.). This estimated data can provide a parametric understanding of the subject's physical structure from a 2D image.

This parametric data can also be fed into a 3DMM sampler 408, which is responsible for determining parameters for the new images to be synthesized. The 3DMM sampler 408 can produce “generated face information” by utilizing the subject's neutral head shape (e.g., from the estimator 406) and combining it with randomly sampled expression offsets (e.g., from a database of human expressions) and camera coordinates (e.g., from a predefined range of viewing angles).

The 3DMM estimator 406 outputs a first set of generated face information (e.g., head information, expression offsets, and camera parameters) corresponding to the reference image(s) which can then be input into a first conditional conversion Module 412 which prepares a first set of conditioning maps (e.g., can be broadly referred to as “helper images” or “helper items of information”) corresponding to each of the one or more reference images. The conditioning maps are for conditioning or helping the diffusion model denoise or create new images.

This first set of condition maps can include 1) a view direction map indicating the camera angle (e.g., V_{ref}), 2) a 3D pose map mapping the image to head parts, e.g., lips, mouth, etc., and showing where the head pose is in the image (e.g., P_{ref}), 3) an expression map showing how each part of the face is deformed from the neural head by the expression offsets (e.g., E_{ref}), 4) an outcropping mask indicating valid image regions which shows which parts of the image is within image borders, and 5) a binary reference mask distinguishing between original reference images and generated images. Also, a sixth piece of information is also used, e.g., 6) a reference latent corresponding to an original reference image, which is described in more detail below.

Similar to the process for the reference images, the 3DMM sampler 408 outputs a second set of generated face information (e.g., head information, expression offsets, and camera parameters) for helping to make the new images which can then be input into a second conditional conversion Module 414 which prepares a second set of conditioning maps for every image to be generated. The second conditional conversion Module 414 can also receive the neutral head information from the 3DMM estimator 406.

Similar to the first set of condition maps corresponding to the reference images, this second set of condition maps for the generated images can include 1) a view direction map indicating the camera angle (e.g., V_{gen}), 2) a 3D pose map mapping the image to head parts, e.g., lips, mouth, etc., and showing where the head pose is in the image (e.g., P_{gen}), 3) an expression map showing how each part of the face is deformed from the neural head by the expression offsets (e.g., E_{gen}), 4) an outcropping mask indicating valid image regions which shows which parts of the image is within image borders, and 5) a binary reference mask distinguishing between original reference images and generated images. Also, a sixth piece of information is also used, e.g., 6) an initial noise image to be used as a starting point for generating a new image via the diffusion process, which is described in more detail below.

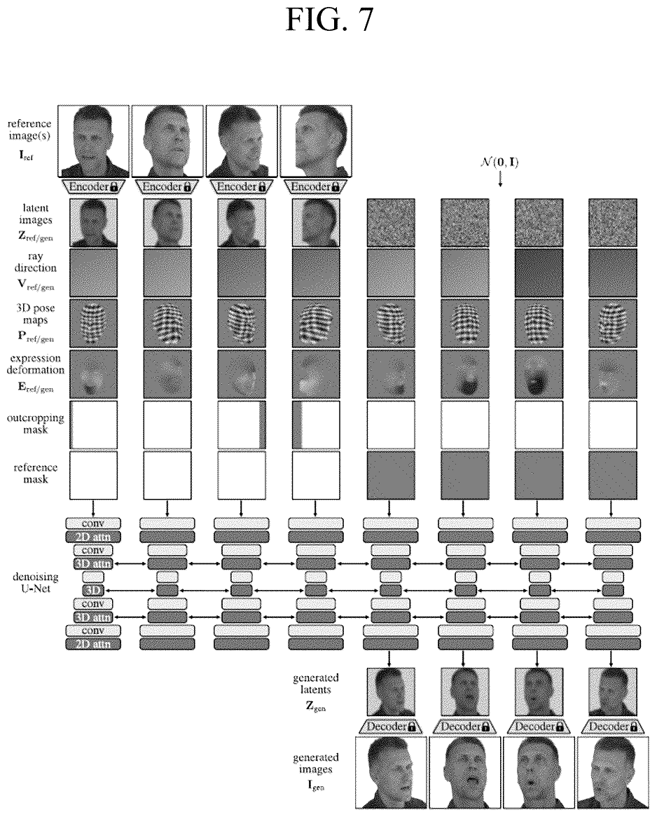

Further in this example, to initiate the generation process a noise generator 410 can sample random noise in the latent space (e.g., Gaussian noise) to create a set of “noisy images” or initialized generated latents (e.g., 840 latents, but embodiments are not limited thereto). These noisy latents serve as a type of starting canvas upon which the image will be constructed. This reverse diffusion process is described in more detail below with reference to FIG. 7.

With reference again to FIG. 4A, the core synthesis occurs in the novel view/expression generator 416, which implements a morphable multi-view diffusion model (MMDM). The MMDM can execute an iterative reverse diffusion process (e.g., over 250 steps) to progressively denoise the latents.

According to an embodiment, a novel view/expression generator 416 can perform an application of stochastic conditioning. Because the MMDM may be limited to processing a small batch of images at once (e.g., 8 images) due to memory constraints, the model can apply stochastic conditioning at each denoising step.

The stochastic conditioning can involve randomly sampling a subset of the reference latents (e.g., Z_{ref}, from encoder 404) and a subset of the currently evolving generated latents (e.g., Z_{gen}) to condition the model. This random shuffling can ensure that the generated views remain consistent with the subject's identity and with each other, which can effectively bridge the gap between the limited reference inputs and the large volume of desired outputs.

Then, once the diffusion process is complete, the refined set of generated latents can be passed to a decoder 418. The decoder 418 can uncompress the latent representations back into pixel space to produce the final output new images 420 (e.g., hundreds of new images). For example, this output can include a plurality of high fidelity synthetic images of the subject exhibiting the sampled poses and the sampled expressions, which are then ready to be used as training data for the subsequent 4D avatar reconstruction stage.

FIG. 4B is a block diagram illustrating the Stage 2 reconstruction pipeline, according to an embodiment of the present disclosure. This stage functions to transform the static image data collected and synthesized in Stage 1 into a dynamic, animatable 3D model (e.g., a “4D avatar” because it can be dynamically animated and move over time).

For example, the process can begin by aggregating the training data, which can include the original reference image(s) 402, the synthesized new images 420 generated by the diffusion model (e.g., in Stage 1), and the corresponding 3DMM parameters 422 (e.g., including head poses, expression coefficients, and camera positions from Stage 1) associated with each image.

Further in this example, the process creates a face model 426 that serves as the geometric foundation for the avatar. Using the head shape and facial structure information derived from the 3DMM parameters, the face model 426 constructs a base 3D mesh. This face model is designed to deform based on expression signals, allowing the geometry to adapt to the specific expression (e.g., a smile or frown) depicted in the current training image.

According to an embodiment, to capture high-fidelity details and non-linear deformations that standard parametric models might miss, the pipeline can employ a UV remeshing module 428 and a UV adjustment module 430. Here, the expression parameters are converted into a UV map representation. Also, the system creates a positional encoding within this UV map and processes it using a neural network (e.g., an expression refinement U-Net). This network outputs a refined expression UV map, which is then masked and converted back into vertex deformations. For example, this process effectively “remeshes” the surface to accommodate complex expression-dependent geometry.

Further in this example, the visual representation is handled by the Gaussian binding module 432. For example, the system can represent the head as a collection of 3D Gaussians (e.g., approximately 100,000 tiny colored blobs of light according to an embodiment). These Gaussians are bound to or defined relative to the deformed mesh triangles generated in the previous steps. This binding can ensure that the underlying mesh moves and deforms with an expression and the volumetric Gaussian representation moves with it to maintain geometric consistency.

Then, a Gaussian rendering Module 434 takes the deformed Gaussian splats and renders them into an image based on the input camera information.

During the training phase, this rendered output is compared against the corresponding ground truth image (e.g., from reference image(s) 402 or new images 420). A loss function calculates the difference between the rendered avatar and the target image, and the system iteratively backpropagates this error to optimize the Gaussian parameters (e.g., position, opacity, color, etc.) and the weights of the expression refinement network.

The final output is a trained 4D avatar model 436, which encapsulates the learned appearance and geometry. Also, the trained 4D avatar model 436 is capable of being animated in real-time even on consumer devices, such as mobile phones, gaming platforms, edge devices, etc.

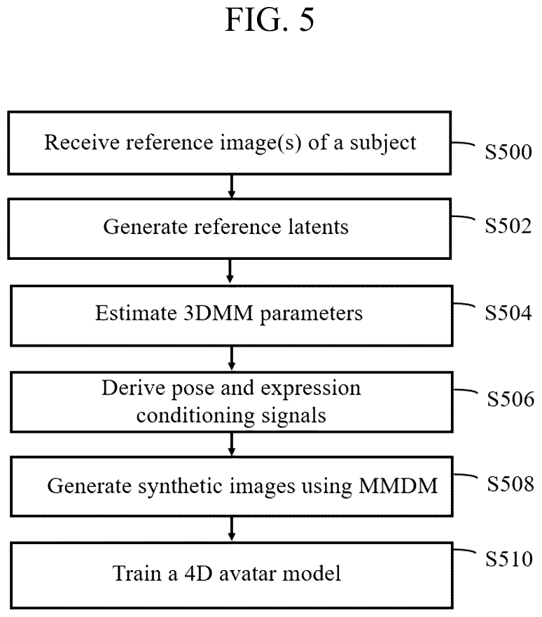

FIG. 5 is a flowchart illustrating a method for generating a 4D avatar model, according to an embodiment of the present disclosure. The operations of the method can be performed by the various components of the AI device 100 (e.g., the Encoder, 3DMM Estimator, MMDM, and Avatar Training Module) described in reference to FIGS. 4A and 4B.

Referring to FIG. 5, the CAP4D method can begin at operation S500 by receiving a set of reference image(s) of a subject. As noted above, this set can include an arbitrary number of images, ranging from a single snapshot to a large collection.

Further, at operation S502, the method can include encoding the set of reference image(s) into a set of reference latents, e.g., utilizing a Variational Autoencoder (VAE) to compress the visual data.

In addition, at operation S504, the method can include estimating 3D Morphable Model (3DMM) parameters for the set of reference images to extract geometric and semantic identity features. Based on these parameters, at operation S506, the method derives pose and expression conditioning signals (e.g., the maps P_{ref} and E_{ref}) used to guide the generation process.

Further still in this example, at operation S508, the method proceeds to generating a plurality of synthetic images of the subject from different viewpoints based on the derived conditioning signals using a morphable multi-view diffusion model (MMDM). According to an embodiment, this generating step is a multi-part process. For example, it can involve initializing a set of generated latents (e.g., noise) and executing an iterative reverse diffusion process on them. Also, the method can apply stochastic conditioning during the steps of this iterative process. This involves randomly sampling a subset of the reference latents and a subset of the generated latents at each step to condition the model, thereby ensuring consistency across large batches. The diffusion process can conclude by decoding the set of generated latents to produce the final plurality of synthetic images.

Then, at operation S510, the method includes training a 4D avatar model based on the combined dataset of the original reference images and the newly generated synthetic images.

As discussed above, this 4D avatar model can utilize 3D Gaussian splatting augmented with an expression-dependent appearance model. Once the 4D avatar model is trained, the method can further include animating a 4D avatar corresponding to the subject in real-time by modulating the Gaussian parameters based on new driving expression signals.

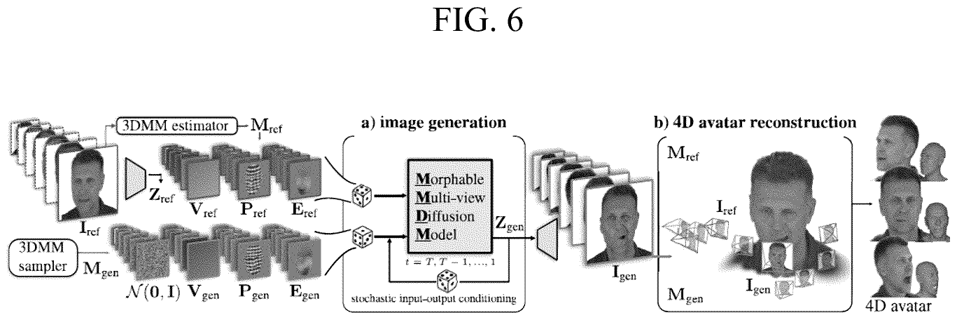

FIG. 6 is a flowchart illustrating an example overview of the CAP4D framework, according to an embodiment of the present disclosure. For example, according to an embodiment, the AI model can be implemented as a cohesive architecture of interconnected modules designed to implement the multi-phase workflow previously described.

According to an embodiment, as an overview, the method can take as input an arbitrary number of reference images (e.g., I_{ref}) that are encoded into the latent space of a variational autoencoder. A face tracker estimates a 3D morphable model (3DMM), e.g., M_{ref}, for each reference image, from which conditioning signals are derived which describe camera view direction, e.g., V_{ref}, head pose P_{ref}, and expression E_{ref}. Also, additional conditioning signals can be associated with each input noisy latent image based on the desired generated viewpoints, poses and expressions.

Further, the morphable multi-view diffusion model (MMDM) can generate images through a stochastic input-output conditioning procedure that randomly samples reference images and generated images during each step of the iterative image generation process. The generated and reference images can be used with the tracked and sampled 3DMMs to reconstruct a 4D avatar based on a 3D Gaussian splatting representation.

As discussed above, according to an embodiment, the CAP4D framework can include of two main stages, e.g., Stage 1 a morphable multi-view diffusion model that generates a large number of novel views from input reference images, and Stage 2 an animatable 4D representation based on 3D Gaussian splatting representation that is reconstructed from the reference and generated images.

Regarding the morphable multi-view diffusion model (MMDM), the MMDM can be trained and can take a set of R reference images, e.g.,

$${I}_{ref} = {\{ {i}_{ref}^{( r )} \}}_{r = 1}^{R} ,$$

as input and outputs G generated images, e.g.,

$${I}_{gen} = {\{ {i}_{gen}^{( g )} \}}_{g = 1}^{G} ,$$

as shown in FIG. 6.

Further the MMDM can be conditioned on additional information including the head pose, expression, and camera view direction for each reference image and each generated image, given as

$${C}_{ref} = {\{ {c}_{ref}^{( r )} \}}_{r = 1}^{R} .$$

In this way, the MMDM can learn the joint probability of generated images according to Equation 1, below.

$$P ( {I}_{gen} \vert {I}_{ref} , {C}_{ref} , {C}_{gen} ) \qquad [ Equation 1 ]$$

Regarding the architecture of the MMDM, the model can be initialized from Stable Diffusion 2.1, and adapted for multi-view generation. For example, a pre-training image autoencoder can be used to encode images into a low-resolution latent space, and a latent diffusion model can process the R reference images, e.g., Z_{ref}, and the G generated latent images, e.g., Z_{gen}, in parallel.

In addition, to share information between the processed latents for each image, the 2D attention layers after 2D residual blocks can be replaced with 3D attention (e.g., two spatial dimensions and one dimension across input images). According to an embodiment, the cross-attention layers can be removed since text conditioning does not have to be used as an input. Then the model can be fine-tuned by optimizing all parameters. However, embodiments are not limited thereto and other types of diffusion models can be adapted for the multi-view generation.

In addition, the model is conditioned on additional images that provide the head pose, expression, camera view and other contextual information for each reference and each generated image.

For example, according to an embodiment, these conditioning images or items of conditioning information can include 3D pose maps, e.g., P_{ref/gen}, that provide the rasterized canonical 3D coordinates of the head geometry, expression deformation maps (e.g., E_{ref/gen}) containing the rasterized 3D deformations of the geometry relative to the neutral expression mesh, view direction maps (e.g., V_{ref/gen}) showing the direction of each camera ray in the first camera reference frame, and binary masks (e.g., B_{ref/gen}) that indicate whether the input is a reference or generated image.

Also, the conditioning information for the reference images can be expressed as C_{ref}={P_{ref}, E_{ref}, V_{ref}, B_{ref}}, and the conditioning information for the reference images (e.g., C_{ref}) can be concatenated with the latent reference images (e.g., Z_{ref}) as input to the network.

Similarly, the conditioning information for the generated images can be expressed as C_{gen}={P_{gen}, E_{gen}, V_{gen}, B_{gen}}, and the conditioning information for the generated images (e.g., C_{gen}) can be concatenated with the latent generated images (e.g., Z_{gen}) as input to the network.

Regarding the 3D pose map conditioning, to obtain the 3D pose maps (e.g., P_{ref/gen}), a head tracker can be used, such as FlowFace. However, embodiments are not limited thereto and other types of head trackers can be used.

For example, the head tracker can operate as a robust 3D face tracking framework that utilizes an iterative, recurrent optical flow mechanism to achieve dense alignment between a 3D face model and 2D input imagery. Instead of relying on sparse landmarks or generic synthetic data, the head tracker can predict a probabilistic UV-to-image flow, which effectively maps points from the 2D texture coordinate system of the 3D surface (UV space) directly to the corresponding pixels in the input video frames. By employing an image feature encoder and a positioning encoding module within a recurrent network, the head tracker can progressively refine the alignment over multiple iterations, allowing it to accurately capture subtle facial deformations and generate high-fidelity 3D animations that faithfully track the subject's movements.

For example, The head tracker can jointly fit a FLAME model to each reference image. However, embodiments are not limited thereto and other types of head models can be used.

Further in this example, the head tracker can provide the shape, head pose, and expression blendshapes, along with camera intrinsics and extrinsics.

Also, the method can include applying the blendshapes to a template model (e.g., T) to recover the 3D models

$$( e . g . , {M}_{ref} = {\{ {m}_{ref}^{( r )} \}}_{r = 1}^{R} )$$

corresponding to each reference image. Similarly, the 3D models

$$( e . g . , {M}_{gen} = {\{ {m}_{gen}^{( g )} \}}_{g = 1}^{G} )$$

can be defined for each of the generated images based on the desired head poses, expressions, and camera positions.

Then, the method can include assigning a texture to each vertex of the 3D models (e.g., M_{ref/gen}) which can include the 3D position of the corresponding vertex in the template mesh T.

Further, the 3D pose map can be rendered by rasterizing the textures of M_{ref/gen} from the viewpoint of each reference image and each generated image, according to Equation 2, below.

$${p}_{ref}^{( r )} = γ [ RASTERIZE ( {m}_{ref}^{( r )} , T , {\prod }_{ref}^{( r )} ) ] \qquad [ Equation 2 ]$$

In Equation 2,

$${p}_{ref}^{( r )} ∈ {P}_{ref}$$

is the 3D pose map for the rth reference image, RASTERIZE performs rasterization of the reference mesh using the associated 3D vertex position textures from the template mesh, and

$${\prod }_{ref}^{( r )}$$

is the camera projection matrix given by the intrinsics and extrinsics. The function gamma (γ) performs positional encoding that maps the rasterized 3D vertex position at each pixel into a high-dimensional feature using sine and cosine functions. Then the 3D pose maps are rendered for the generated images in the same fashion.

Regarding the expression deformation map conditioning, to facilitate the generation of subtle expression changes, the network can be explicitly conditioned utilizing expression deformation maps (e.g., E_{ref/gen}).

According to an embodiment, a procedure similar to that used for the 3D pose map can be employed, with the distinction that a different texture is assigned to each vertex of the mesh (e.g., M_{ref/gen}). For example, at each vertex, the system can calculate a 3D offset relative to a corresponding vertex of a 3D model that shares the same shape blendshapes but utilizes a neutral expression blendshape.

Subsequently, these vertex textures can be rasterized from the camera viewpoints associated with the reference and generated images. Also, the positional encoding step may be omitted in this configuration for the expression deformation map conditioning because the expression deformations typically exhibit relatively low spatial frequencies.

According to an embodiment, the system utilizes view direction map and mask conditioning. For each reference image and generated image, corresponding per-pixel ray directions can be encoded into images (e.g., V_{ref/gen}). These ray directions can be expressed with respect to a reference frame of a first view, based on estimated camera intrinsics and extrinsics derived from the head tracker.

Additionally, a binary mask can be employed to indicate whether a specific input image is a reference image or a generated image, while an outcropping mask can be used to identify padded regions added to the reference images (e.g., after center cropping is performed around the head). According to an embodiment, all conditioning images are rendered at the latent image resolution and concatenated to the reference and generated latent images prior to being input into the MMDM. However, embodiments are not limited thereto.

Regarding generation of the new images, according to an embodiment, the first stage of the 4D avatar reconstruction procedure includes an iterative image generation process. For example, given an arbitrary number of reference images as input, the system generates hundreds of novel views exhibiting a range of expressions.

Further, this process can utilize inference with stochastic input-output (I/O) conditioning. Typically, the appearance of occluded head regions and expression-dependent features (e.g., hair on the back of the head, teeth covered by lips, wrinkles, etc.) can remain ambiguous if only a small number of reference images are provided. Furthermore, certain MMDM architectures may be limited to processing a fixed number of reference images (e.g., up to four) as input in a single forward pass. Consequently, outputs of the model generated using different subsets of reference images could theoretically exhibit divergent likenesses.

To mitigate these issues, according to an embodiment, the system can employ a stochastic I/O conditioning procedure in which a random subset of input reference images and a random subset of generated images is passed to the model at each diffusion timestep. This procedure provides multiple technical advantages, e.g., 1) it improves the consistency of the generated images, 2) it provides a mechanism to condition the model on a large volume of reference images (e.g., tens to hundreds, or more), and 3) it enables the generation of hundreds of consistent output images.

According to an embodied, a detailed description of stochastic I/O conditioning is provided in Algorithm 1 shown in Table 1 below.

TABLE 1
Alg. 1: Inference with Stochastic I/O Conditioning

```
Input: Reference image latents and conditioning
  Z_{ref}, C_{ref}, C_{gen}
  R = |Z_{ref}| = |C_{ref}|, G = |C_{gen}|
  G′: generated latents in each forward pass
Output: Generated image latents Z_{gen}
Z_{gen,T} ~ [symbol]    (0, I) / /  sample noisy latents
for t in (T, T = 1, . . . , 1) do
  | / / shuffle generated latents
  |  $( {Z}_{ref}^{′} , {C}_{ref}^{′} ) ← RANDSAMPLE ( ( {Z}_{ref} , {C}_{ref} ) )$
  | for i in (0, . . . , G − 1) do
  | | / / sample w/o replacement
  | |  $( {Z}_{ref}^{′} , {C}_{ref}^{′} ) ← RANDSAMPLE ( ( {Z}_{ref} , {C}_{ref} ) )$
  | | / / sample next batch
  | |  $( {Z}_{gen}^{′} \text{?} , {C}_{gen}^{′} ) ← ( {Z}_{gen} \text{?} , {C}_{gen} ) [ {iG}^{′} + 1 : ( i + 1 ) {G}^{′} ]$
  | | / / predict noise
  | |  $\text{?} = MMDM ( {Z}_{gen , t}^{′} \vert {Z}_{ref}^{′} , {C}_{ref}^{′} , {C}_{gen}^{′} )$
  | | / / apply DDIM step [72]
  | |_  ${Z}_{gen , t - 1}^{′} = \sqrt{{α}_{t - 1}} ( \frac{{z}_{gen , t} - \sqrt{1 - {α}_{t}} \text{?}}{\sqrt{{α}_{t}}} ) + \sqrt{1 - {α}_{t - 1}} \cdot \text{?}$
  |_
return Z_{gen} := Z_{gen,0}
```

$\text{?} \text{indicates text missing or illegible when filed}$

According to an embodiment, the system can execute an inference procedure utilizing stochastic input-output (I/O) conditioning, as detailed in the algorithm 1 illustrated in Table 1 above. This procedure builds upon denoising diffusion implicit model (DDIM) sampling but introduces a novel inner loop structure to enhance multi-view consistency.

Specifically, within each diffusion timestep according to Algorithm 1, the system creates an inner loop where the set of generated images (e.g., the latents being synthesized) are shuffled and processed in batches.

For example, inside this inner loop, for each batch of generated images being processed, the method samples a corresponding random subset of the original reference images. Consequently, the model predicts the denoised latent images for the subsequent diffusion timestep conditioned on a mix of the current batch of generated latents and the sampled reference latents.

This process repeats until the system has iterated through all generated images for that timestep. By proceeding in this manner through all diffusion steps (e.g., 250 steps according to an embodiment), the method can ensure that all reference images and all generated images participate jointly and iteratively in the generation process, thereby maximizing identity preservation and geometric consistency across the entire dataset.

For example, according to an embodiment, the method improves upon standard denoising diffusion implicit model (DDIM) sampling. Standard DDIM is deterministic, meaning the path from initial noise to the final image is fixed and predictable. However, this rigidity can be a limitation when processing varying amounts of reference data. Algorithm 1 modifies this framework by re-introducing randomness (stochasticity) in a specific way.

Instead of just adding random noise to the image data itself, the system randomly varies the conditioning signals. By randomly sampling different subsets of reference and generated images at each step of the process, the system prevents the model from relying too heavily on a specific set of views. This forces the generation process to gather features from the entire pool of reference images over time, which results in a consistent set of new views that avoids the errors or artifacts often found in standard deterministic sampling.

FIG. 7 illustrates a detailed implementation of the Morphable Multi-View Diffusion Model (MMDM) processing a specific batch of data, according to an embodiment.

In this example configuration, the model is configured to process a combined batch including four reference images and four generated images simultaneously. To enable the network to distinguish between valid ground truth data and the noise being resolved, while accurately placing the subject in 3D space, each image in the batch can be represented by a multi-channel tensor constructed from six distinct items of information.

For example, for each of the four reference images, the input tensor can be constructed by concatenating: 1) a latent representation (e.g., Z_{ref}), which is the compressed feature map of the original pixel image encoded by the VAE, 2) a view map (e.g., V_{ref}), encoding the camera ray directions relative to the subject, 3) a 3D pose map (e.g., P_{ref}), representing the geometric orientation of the head, 4) an expression map (e.g., E_{ref}), detailing the specific facial deformations (e.g., a smile or frown) associated with that reference image, 5) an outcropping mask, which identifies any padded regions added during preprocessing, and 6) a reference mask, which is a binary indicator set to a first value (e.g., 1) to explicitly inform the network that this input is a ground truth reference image containing valid identity information.

Similarly, for each of the four generated images (e.g., the targets being synthesized), the input tensor can be constructed from six corresponding items: 1) sampled noise (or the partially denoised latent from the previous timestep) (e.g., Z_{gen}), which can serve as the canvas for generation, 2) a sampled view map (e.g., V_{gen}), defining the novel camera angle desired for the output, 3) a sampled 3D pose map (e.g., P_{gen}), defining the target head orientation, 4) a sampled expression map (e.g., E_{gen}), defining the target facial expression, 5) an outcropping mask (e.g., typically fully valid for generated images), and 6) a reference mask, which is set to a second value (e.g., 0) to inform the network that this input is a generated image currently undergoing the diffusion process.

As shown in FIG. 7, the MMDM processes this combined batch of eight inputs (e.g., 4 reference+4 generated) through a specialized denoising U-Net. Unlike standard U-Nets that process images in isolation, this architecture is designed to foster information exchange between the reference and generated views.

Further, the network layers can be arranged in a specific interleaved sequence to alternate between spatial feature extraction and multi-view correlation. According to an embodiment, the layer sequence can include a convolutional layer (conv) to extract initial features; followed by a 2D attention layer (2D attn) for spatial context within each image; followed by a convolutional layer, followed by a series of 3D attention layers (3D attn) interleaved with convolutional layers. For example, the sequence can proceed as conv, 3D attn, conv, 3D attn, conv, 2D attn.

Also, the 3D attention layers can allow the model to perform attention across the batch, enabling the generated images to “attend” to the features of the reference images to ensure identity consistency across all views.

Upon completion of the U-Net processing steps, the model outputs the predicted noise of that step or clean latents for the four generated images. Once the iterative diffusion process concludes (e.g., after the final timestep), these refined latents (e.g., clean, denoised latents) are passed to the decoder.

The decoder can upsample the latent representations, converting them from the compressed feature space back into high-resolution pixel space, thereby yielding the final four generated images which depict the subject with the specific poses and expressions defined by the sampled conditioning maps.

This process can be repeated for additional views and variations in expressions to create hundreds or thousands of novel synthetic images that can be used for training the 4D avatar model.

According to an embodiment, the MMDM model architecture can be based on a latent diffusion framework (e.g., Stable Diffusion 2.1). For example, to create the multi-view diffusion model, cross-attention layers may be removed, and 2D self-attention layers located after 2D residual blocks may be replaced with 3D attention layers.

For example, this modification of the 2D self-attention mechanism can be applied to layers with dimensions of 32×32, 16×16, and 8×8. Additionally, the first convolutional layer of the model is adjusted to accommodate the additional conditioning channels. Also, where feasible, layers may be initialized utilizing pre-trained weights.

During the training phase, all model parameters are updated, and the process generally follows latent diffusion protocols with specific adjustments.

First, the signal-to-noise ratio (SNR) of the noise schedule can be shifted by a factor of log(√N). Adjusting the noise schedule in this manner can provide a greater number of diffusion steps, thereby allowing the model to effectively learn coarse structures in the generated images.

Second, the noise schedule can be adjusted to have zero terminal SNR, which can improve avoiding artifacts in the background. In a specific implementation, the latent diffusion model can include a total of approximately 815 million parameters. Further, a classifier-free guidance weight (e.g., a weight of 2) can be utilized during the sampling process.

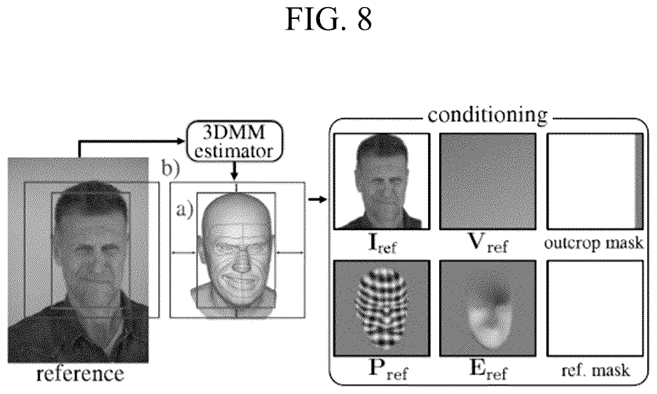

FIG. 8 illustrates MMDM conditioning and preprocessing each reference image based on the estimated 3DMM model, according to an embodiment. For example, the morphable multi-view diffusion model (MMDM) is configured to receive as input a set of reference images and a set of generated images, in which each image set is paired with a plurality of additional sets of conditioning images, as illustrated in FIG. 8.

For example, according to an embodiment, these conditioning images can include view direction maps (e.g., V_{ref/gen}) containing per-pixel view directions expressed in world coordinates, 3D pose maps (e.g., P_{ref/gen}) including rasterized vertex positions of the 3DMM template mesh, and expression deformation maps (e.g., E_{ref/gen}) including rasterized vertex deformation vectors.

In addition, the conditioning input can include mask data (B_{ref/gen}), which includes pairs of binary masks configured to indicate 1) outcropped areas where the image has been padded (e.g., with white pixels), and 2) a flag indicating whether the specific input is a reference image or a generated image.

Regarding the preprocessing steps and the generation of binary masks, to create the reference conditioning images, the system can first acquire 3DMM parameters (e.g., FLAME parameters), camera intrinsic parameters, and extrinsic parameters utilizing the 3DMM estimator. Conversely, to create the generated conditioning images, the system can sample the 3DMM/FLAME parameters, which is described in more detail at below.

According to an embodiment, the reference images can undergo a specific cropping procedure. For example, as shown in FIG. 8, a bounding box can first be fitted around the vertices of the 3DMM projected onto the camera image plane.

Further, the system can then identify the smallest square bounding box that encloses the original bounding box (e.g., centered at the same location) and enlarges the result by a predetermined amount (e.g., 30%) to sufficiently include features such as the hair, neck, and shoulders.

Then, this enlarged bounding box can be utilized for cropping the image. Subsequently, the cropped image can be resized to a target resolution (e.g., 512×512), and the camera intrinsics are adjusted to be consistent with this cropped frame.

Additionally, the background can be removed using a background matting model. In instances where the bounding box used to crop the image extends outside the image boundaries, the system can perform outcropping by padding the image with specific pixel values (e.g., white pixels).

These padded regions are flagged using a binary cropping mask, in which all outcropped areas are indicated. Consequently, the MMDM is conditioned on the mask data (e.g., B_{ref/gen}), which includes these outcropping masks and the binary masks indicating the source type of the input image.

According to an embodiment, regarding the view direction conditioning, the system utilizes camera intrinsic and extrinsic parameters to compute view conditioning images (e.g., V_{ref/gen}). These images contain the view direction for each pixel expressed in world coordinates. Further, the world coordinates can be computed relative to a first reference view, which is typically positioned at the origin of the coordinate system with a rotation matrix set to the identity matrix.

According to an embodiment, with respect to 3D pose and expression conditioning, the 3D pose map (e.g., P_{ref/gen}) can be obtained by texturing the vertices of the tracked 3DMM model utilizing the 3D vertex positions of the 3DMM template mesh (T). The system can rasterize these vertex positions and encode the resulting values utilizing a periodic positional encoding, for example, according to Equation 3 below.

$$γ ( p ) = ( sin ( {2}^{0} p ) , cos ( {2}^{0} p ) , … , sin ( {2}^{L − 1} p ) , cos ( {2}^{L − 1} p ) ) , \qquad [ Equation 3 ]$$

In Equation 3, p represents the 3D vertex position texture, and L represents the number of encoding frequencies (e.g., where L=7). In this example implementation, this results in 42 positional encoding channels.

Further, the expression deformation map (e.g., E_{ref/gen}) is computed in a similar manner by rasterizing the 3D deformations caused by the expression blendshape parameters (e.g., & (Ø)), however, in this example, the positional encoding is omitted.

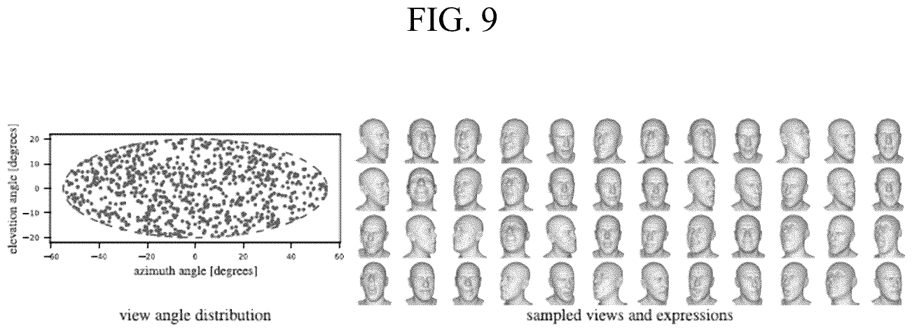

FIG. 9 shows an example of the MMDM sampling, according to an embodiment. For example, to generate novel views the system can uniformly sample in azimuth and elevation (e.g., left portion of FIG. 9). For each camera view, unique expression parameters can be selected from an expression database (e.g., Nersemble dataset) following a diversity-promoting sampling scheme. A subset of the sampled expressions and views are shown on the right portion of FIG. 9.

In more detail, according to an embodiment, a fixed sampling procedure can be utilized to obtain novel generated views and 3DMM parameters, as illustrated in FIG. 9. The process can include sampling a set of generated camera views, in which each view is rotated around the center of the head utilizing a randomly sampled azimuth and elevation angle. In this configuration, a view aligned directly straight on with the face is defined as having zero azimuth and zero elevation.

Further in this example, the virtual camera is maintained at the same distance from the head as the camera distance associated with the first reference view. The values for the azimuth and the elevation angle are uniformly sampled to reside within an elliptical region as shown in FIG. 9, according to Equation 4 below.

$${( \frac{ψ}{{ψ}_{max}} )}^{2} + {( \frac{θ}{{θ}_{max}} )}^{2} < 1 , \qquad [ Equation 4 ]$$

where ψₘₐₓ=55° and θₘₐₓ=20°.

As shown above, in an example embodiment, the maximum azimuth is set to 55 degrees and the maximum elevation angle is set to 20 degrees. However, embodiments are not limited thereto and the values can be adjusted according to design considerations.

According to an embodiment, with respect to expression conditioning, the system is configured to select a unique expression parameter for each camera view from a pre-constructed expression database.

For example, this database can be created utilizing a diversity-promoting sampling scheme (e.g., as implemented in the diversipy software package). The sampling scheme operates by partitioning a space of expressions, such as those obtained from all frames of a comprehensive dataset like Nersemble, into a plurality of dissimilar subsets (e.g., where G=840) and identifying a representative sample for each subset.

Further, to determine the distance between each expression sample during this process, the method can utilize a Euclidean distance calculation within the expression parameter space, wherein each dimension is weighted based on the maximum vertex displacement of the corresponding blendshape.

According to an embodiment, the 3D Morphable Model (e.g., the FLAME representation) can consist of Nᵥ=5023 vertices, which are controlled by identity shape parameters (B), expression shape parameters (Ø), and skeletal joint poses through linear blend skinning.

In this example configuration, the specific jaw pose parameter may be ignored in favor of using a specific model version (e.g., FLAME2023) that incorporates deformations resulting from jaw rotation directly within the expression blendshapes. Overall, the model utilizes β∈ [symbol] ¹⁵⁰ identity shape parameters and φ∈ [symbol] ⁶⁵ expression parameters.

Further, to model eye rotation, a single joint rotation may be utilized for both eyes. Also, each vertex position can be determined by adding expression and identity shape offsets to a template mesh (T), in which the offsets are computed using the expression and identity shape parameters and their corresponding linear bases, ε and S, according to Equation 5 below.

$$m = T + ε ( ∅ ) + S ( B ) \qquad [ Equation 5 ]$$

Further in this example, an edited version of the template mesh can be utilized to create the conditioning signals used by the MMDM. For example, a spherical mesh is positioned within the mouth region and behind the lip to represent the upper jaw. This sphere is configured to be static and unaffected by the expression shape parameters. Additionally, lower neck vertices may be removed to limit the conditioning model specifically to the head region.

Regarding the representation utilized for the 4D avatar, a spherical mesh may be added to model the lower jaw. This sphere is placed similarly to the upper jaw mesh but is rigged to move in coordination with the jaw joint. The jaw rotation is computed heuristically by tracking a deformation vertex on the lower jaw relative to a jaw joint position obtained from the model. Additionally, the UV mapping may be adapted from existing standards and modified to include textures for the upper and lower jaw meshes.

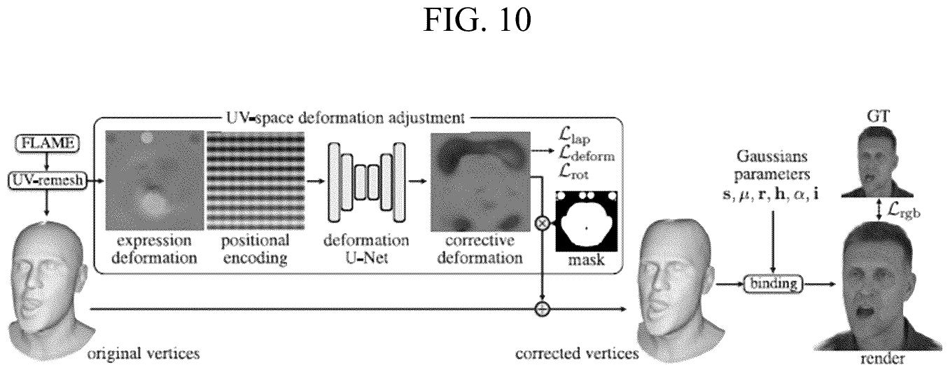

FIG. 10 illustrates an overview of the 4D avatar model according to an embodiment. For example, the 4D representation can incorporate multiple advances in design. For example, according to an embodiment, the FLAME topology can be first re-meshed such that each vertex corresponds to a pixel in the UV space.

Subsequently, UV-space deformations caused by expression blendshapes, along with a UV-space positional encoding, can be provided as input to a deformation U-Net. This U-Net can be configured to output corrective deformations, which, following a masking operation, are added to the remeshed FLAME output.

Further, the 3D Gaussians can be parameterized by a scale s, a local position μ, a local rotation r, spherical harmonics coefficients h, an opacity α, and a parent triangle index i.

During the optimization process, regularizers may be applied to the output of the U-Net, and a learned perceptual image Patch similarity (LPIPS) penalty may be added to the photometric loss.

In more detail regarding the 4D avatar model, according to an embodiment, the system synthesizes a 4D avatar utilizing the reference images, generated images, FLAME parameters, and camera views as inputs.

Further, the underlying representation can be constructed based on a Gaussian splatting framework (e.g., GaussianAvatars) which utilizes a collection of 3D Gaussian splats attached to the triangles of a parametric head mesh (e.g., a FLAME mesh). In this example configuration, each Gaussian is linked to a specific parent triangle, with deformations modeled by expression blendshapes that drive the mesh and triangle deformations. Also, additional Gaussians may be added during the optimization phase by splitting existing Gaussians and assigning the newly created Gaussians to the same parent triangle.

In addition, distinct from existing approaches, the system is configured to remesh the parametric head to achieve pixel-aligned vertices in UV space (e.g., at a resolution of 128×128). To capture fine-grained, expression-dependent deformations, a U-Net is employed to predict a UV deformation map based on offsets in UV space resulting from the expression blendshape. This process utilizes the modified parametric mesh described herein, which includes an upper jaw mesh and an additional lower jaw mesh.

To optimize the representation, the generated images are utilized alongside the sampled expression parameters, head poses, and camera poses. Additionally, the optimization process applies Laplacian regularization to the predicted deformation map and an L₂ regularization to the relative deformation and rotation of every Gaussian splat. To improve robustness, a Learned Perceptual Image Patch Similarity (LPIPS) loss is included, in which the LPIPS weight is increased linearly corresponding to the number of iterations.

In more detail, with respect to the deformation model, according to an embodiment, the per-frame fine-tuning of FLAME parameters, e.g., a technique that can be utilized, is disabled during training to prevent overfitting. Instead, to correct inaccuracies in the underlying 3DMM, the system utilizes a U-Net to deform the mesh with expression-dependent deformations.

The input to the U-Net can include UV maps that encode the expression deformations and positional encodings of UV map pixel locations. To compute the expression deformation map, the FLAME head is first remeshed to achieve pixel-aligned vertices in UV space, for example, at a 128×128 resolution.

Subsequently, the deformations caused by the expression parameters are rasterized into UV space. A positional encoding of the UV space is obtained by encoding the UV coordinates utilizing periodic functions (e.g., as described in the Equation above). In this configuration, the number of frequencies can be set to L=6 and the coordinate p can be set to the UV-space coordinate of each pixel, leading to a total of 24 encoding channels. This positional encoding is concatenated to the UV-space expression deformation and processed by the U-Net (e.g., a 6-layer U-Net).

According to an embodiment, the U-Net is configured to output a 3-channel deformation map (e.g., Dᵤᵥ), as illustrated in FIG. 10, which indicates an expression-dependent deformation correction. This deformation map can be masked to prevent unintended deformations in static areas, such as the back of the head and the lower neck.

Further, to obtain the final vertex positions, these deformations are added to the vertices produced by the parametric model (e.g., the FLAME model).

During the training phase, multiple regularizers can be employed to prevent motion artifacts. First, a weight decay (e.g., 2×10⁻³) may be applied to the weights of the U-Net. Second, an L2 loss

$${ℒ}_{lap} = {‖ Δ {D}_{uv} ‖}_{2}^{2}$$

can be utilized on the Laplacian of the deformation map.

Also, an L2 loss can be applied on the relative deformation and rotation of each Gaussian L_{deform} and Lᵣₒₜ. Further, according to an example embodiment, the learning rate of this network can be logarithmically decreased (e.g., from 10⁻⁵ to 10⁻⁷) during the training process.

With respect to the LPIPS loss, to render the reconstruction more robust to inconsistencies in the generated views, a Learned Perceptual Image Patch Similarity (LPIPS) loss is added to the existing photometric loss. This additional loss term is weighted against the other terms according to Equation 6 below.

$${ℒ}_{rgb} = {λ}_{LPIPS} {ℒ}_{LPIPS} + ( 1 - {λ}_{LPIPS} ) {ℒ}_{rgb , GA} \qquad [ Equation 6 ]$$

In Equation 6, λ_{LPIPS} represents the weighting of the LPIPS loss. According to a specific example implementation, this weighting is linearly increased from 0 to 0.9 during the training process. Further, L_{rgb,GA} represents the original photometric loss utilized in the baseline architecture.

Furthermore, the optimization framework may also include scaling and positional losses, denoted as L_{scaling} and Lₚₒₛᵢₜᵢₒₙ, respectively, as shown in Equation 7 below.

$$ℒ = {ℒ}_{rgb} + {λ}_{deform} {ℒ}_{deform} + {λ}_{rot} {ℒ}_{rot} + {ℒ}_{scaling} + {ℒ}_{position} \qquad [ Equation 7 ]$$

In the context of Equation 7, λ_{deform} and λᵣₒₜ represent the weighting coefficients for the corresponding deformation and rotation losses. According to a specific example implementation, these weights may be set to values such as λ_{deform}=0.4 and λ_{deform}=0.005. However, embodiments are not limited thereto and the weights can be adjusted according to design considerations.

According to an embodiment, the 3D Gaussians are attached to the triangles of the re-meshed parametric model (e.g., the re-meshed FLAME model). Each Gaussian primitive can include a specific set of parameters, including a scale s, a local position μ, a local rotation r, spherical harmonics coefficients h, an opacity α, and a parent triangle index i.

Regarding the initialization process, according to an embodiment, the system is configured to determine the number of Gaussians for each triangle such that the count is proportional to the area of the respective triangle.

In an example embodiment, the initial total number of Gaussians is set to approximately 100,000. Furthermore, the initial scale of each Gaussian is set to be inversely proportional to the number of Gaussians allocated to that triangle, a configuration that effectively reduces rendering artifacts. However, embodiments are not limited thereto.

Various experiments were carried out against related art models to evaluate the results for different parts of the pipeline architecture in FIG. 6.

As shown in Table II below, the model according to embodiments outperforms other related-art methods.

TABLE II

| | single reference image | | | | | 10 reference images | | | | 100 reference images | | | |
|---|---|---|---|---|---|---|---|---|---|---|---|---|---|
| Method | PSNR↑ | LPIPS↓ | CSIM↑ | JOD↑ | Method | PSNR↑ | LPIPS↓ | CSIM↑ | JOD↑ | PSNR↑ | LPIPS↓ | CSIM↑ | JOD↑ |
| Voodoo3D | 19.05 | 0.381 | 0.282 | 4.782 | [symbol] | [symbol] | 0.450 | 0.475 | 3.89 | 16.61 | 0.446 | 0.435 | 3.86 |
| GAGAvatar | 20.78 | 0.373 | 0.457 | 5.034 | FlashAvatar | 14.21 | 0.456 | 0.489 | 2.92 | 22.87 | 0.313 | 0.731 | [symbol] |
| [symbol] | 17.42 | 0.417 | 0.420 | 4.681 | [symbol] | 18.97 | 0.448 | 0.478 | 4.33 | 20.01 | 0.416 | 0.722 | 5.10 |
| Portrait4D-v2 | 16.94 | 0.404 | 0.436 | 3.871 | no MMDM | 17.05 | 0.404 | 0.578 | 4.19 | 19.07 | 0.333 | 0.758 | 4.97 |
| MMDM only | 21.82 | 0.317 | 0.632 | 5.397 | MMDM only | 23.82 | 0.270 | 0.804 | [symbol] | 24.12 | 0.266 | 0.803 | 6.14 |
| CAP4D | 21.69 | 0.311 | 0.633 | 5.672 | CAP4D | 23.19 | 0.265 | 0.779 | 6.13 | 23.30 | 0.257 | 0.792 | 6.15 |

[symbol]

indicates data missing or illegible when filed

With reference to Table II, a summary of example, non-limiting experimental results is shown, comparing the performance of the disclosed method according to embodiments against related art methods for data generation.

As demonstrated by the performance metrics, the present method (CAP4D) achieves superior rendering fidelity (high Peak Signal-to-Noise Ratio) and more robust identity preservation (high Cosine Similarity) across the entire spectrum of input data sizes, ranging from single-shot inputs to large image collections.

A further advantage is the scalability provided by the stochastic conditioning mechanism, whereas conventional methods or non-stochastic variants suffer from quality degradation and overfitting when processing larger datasets, the disclosed stochastic approach effectively leverages the additional data to progressively enhance the realism and consistency of the generated avatar, ensuring that the system improves rather than deteriorates as more reference images are provided.

According to an embodiment, the AI device 100 can be configured to achieve improved generation of animatable 4D avatars suitable for deployment in various types of interactive environments, such as telepresence, virtual reality, and gaming. The AI device 100 can be used in various types of different situations.

According to one or more embodiments of the present disclosure, the AI device 100 can solve one or more technological problems in the existing technology, such as implementing a scalable framework for generating animatable 4D avatars from arbitrary image collections. This framework can effectively bridge the gap between single or few-shot generation and dense 3D reconstruction by utilizing a stochastic conditioning mechanism within a diffusion model to synthesize consistent multi-view data, which then drives the training of a real-time, expression-dependent 3D Gaussian splatting model.

For example, embodiments of the present disclosure can address the deficiencies of the related art 4D avatar generation techniques, which often suffer from rigid input requirements (e.g., requiring complex multi-camera rigs), a lack of geometric consistency when generating novel views from limited data, and prohibitive computational costs (e.g., like those associated with neural radiance fields NeRFs) that prevent real-time rendering on consumer hardware.

Also, according to an embodiment, the AI device 100 configured with the 4D avatar generation pipeline can be used in a mobile terminal, a virtual reality (VR) headset, a smart TV, a gaming console, a telepresence system, an infotainment system in a vehicle, etc.

For example, the AI device can be applied in a wide range of interactive applications including virtual reality (VR) telepresence systems, augmented reality (AR) communication platforms, and immersive digital environments (e.g., the metaverse). For example, according to an embodiment, a user in a VR environment can be represented by a photorealistic 4D avatar generated from their own photos, allowing for natural, face-to-face interactions with other users where facial expressions and emotional cues are accurately conveyed in real-time.

For example, methods and systems disclosed herein have broad applicability across a wide range of industries and technical fields that utilize digital human representation. The 4D avatar models trained using the synthetic data generated by the disclosed pipeline can be well suited for deployment on resource constrained edge devices where real-time, low-latency rendering is desirable.

Non-limiting examples of such applications include mobile communications and social media platforms. The disclosed embodiments can allow users to generate high-fidelity, animatable avatars using only a few selfies captured on a smartphone. These avatars can then be utilized in low bandwidth video calls, where instead of streaming heavy video data, the device can transmit only lightweight expression parameters (e.g., coefficients) to animate the avatar on the receiver's device, thereby saving bandwidth while maintaining visual fidelity.

Further, the disclosed method can provide significant advantages for the gaming and entertainment industry, where personalized character creation is desirable. The trained models can be integrated into game engines to allow players to instantly digitize themselves or other personalized characters into the game world. The ability to generate consistent 3D texture and geometry from a user's own selected photos allows for the creation of highly realistic player avatars without the need for expensive scanning equipment or manual artistry.

In an enterprise or commercial context, the method can be used to develop and train specialized virtual agents for customer service, digital kiosks, or educational tutoring systems. By providing a photorealistic visual interface that can react dynamically with appropriate facial expressions, these systems can enhance user engagement and trust.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor of the AI device, a set of reference images of a subject, wherein the set of reference images includes one or more images;
encoding, by the processor, the set of reference images into a set of reference latents;
estimating, by the processor, 3D morphable model (3DMM) parameters for the set of reference images;
deriving, by the processor, pose and expression conditioning signals based on the 3DMM parameters;
generating, by the processor, a plurality of synthetic images of the subject from different viewpoints based on the pose and expression conditioning signals using a morphable multi-view diffusion model, wherein the generating the plurality of synthetic images includes:
executing an iterative reverse diffusion process on a set of generated latents,
applying stochastic conditioning during steps of the iterative reverse diffusion process by randomly sampling a subset of the set of reference latents and a subset of the set of generated latents to condition the morphable multi-view diffusion model, and
decoding the set of generated latents to produce the plurality of synthetic images; and
training, by the processor, a 4D avatar model based on the set of reference images and the plurality of synthetic images to generate a trained 4D avatar model, wherein the 4D avatar model utilizes 3D Gaussian splatting augmented with expression dependent appearance model information.

2. The method of claim 1, further comprising animating, by the trained 4D avatar model, a 4D avatar corresponding to the subject.

3. The method of claim 1, wherein the deriving pose and expression conditioning signals includes:
generating, for each image in the set of reference images and for each synthetic image to be generated, a set of conditioning maps including one or more of a view direction map encoding camera ray directions, a 3D pose map representing rasterized vertex positions of a template mesh, and an expression deformation map representing rasterized vertex deformations relative to a neutral expression mesh.

4. The method of claim 1, wherein the applying stochastic conditioning includes randomly selecting different subsets of the set of reference latents to condition different groupings of the set of generated latents during the iterative reverse diffusion process.

5. The method of claim 1, wherein the morphable multi-view diffusion model includes a U-Net architecture including 3D attention layers configured to perform attention to correlate features between the subset of the set of reference latents and the subset of the set of generated latents.

6. The method of claim 1, wherein the stochastic conditioning enables the morphable multi-view diffusion model to generate consistent synthetic images regardless of a number of images in the set of reference images.

7. The method of claim 1, wherein the 4D avatar model includes a plurality of 3D Gaussian primitives, and
wherein the training the 4D avatar model includes initializing the plurality of 3D Gaussian primitives by attaching each 3D Gaussian primitive to a specific parent triangle of a parametric mesh derived from the 3DMM parameters.

8. The method of claim 7, wherein the expression dependent appearance information is generated by an expression dependent appearance model that includes a neural network configured to receive expression coefficients associated with the subject and dynamically modulate color properties or coefficients of the plurality of 3D Gaussian primitives based on the expression coefficients.

9. The method of claim 7, wherein the training the 4D avatar model further includes:
remeshing the parametric mesh to obtain pixel-aligned vertices in a UV space;
converting expression parameters into a UV map representation; and
utilizing a deformation network to predict a UV deformation map based on the UV map representation to correct or augment facial deformations.

10. The method of claim 1, wherein the training the 4D avatar model includes optimizing parameters of the 3D Gaussian splatting by minimizing a loss function that compares a rendered image of the 4D avatar model against a corresponding image from the set of reference images or the plurality of synthetic images.

11. The method of claim 1, further comprising animating, by the trained 4D avatar model, a 4D avatar corresponding to the subject in real-time by rendering the 4D avatar model on a mobile device by updating the expression dependent appearance model information based on a driving signal while maintaining a static set of canonical Gaussian parameters.

12. An artificial intelligence (AI) device, comprising:
a memory configured to store information for a morphable multi-view diffusion model; and
a controller configured to:
receive a set of reference images of a subject, wherein the set of reference images includes one or more images,
encode the set of reference images into a set of reference latents,
estimate 3D morphable model (3DMM) parameters for the set of reference images,
derive pose and expression conditioning signals based on the 3DMM parameters,
generate a plurality of synthetic images of the subject from different viewpoints based on the pose and expression conditioning signals using the morphable multi-view diffusion model, wherein generating the plurality of synthetic images includes:
executing an iterative reverse diffusion process on a set of generated latents,
applying stochastic conditioning during steps of the iterative reverse diffusion process by randomly sampling a subset of the set of reference latents and a subset of the set of generated latents to condition the morphable multi-view diffusion model, and
decoding the set of generated latents to produce the plurality of synthetic images, and
train a 4D avatar model based on the set of reference images and the plurality of synthetic images to generate a trained 4D avatar model, wherein the 4D avatar model utilizes 3D Gaussian splatting augmented with expression dependent appearance model information.

13. The AI device of claim 12, wherein the controller is further configured to animate, by using trained 4D avatar model, a 4D avatar corresponding to the subject in real time.

14. The AI device of claim 12, wherein the controller is further configured to:
generate, for each image in the set of reference images and for each synthetic image to be generated, a set of conditioning maps including one or more of a view direction map encoding camera ray directions, a 3D pose map representing rasterized vertex positions of a template mesh, and an expression deformation map representing rasterized vertex deformations relative to a neutral expression mesh,
wherein the pose and expression conditioning signals are based on the set of conditioning maps.

15. The AI device of claim 12, wherein the controller is further configured to randomly select different subsets of the set of reference latents to condition different groupings of the set of generated latents during the iterative reverse diffusion process for the stochastic conditioning.

16. The AI device of claim 12, wherein the morphable multi-view diffusion model includes a U-Net architecture including 3D attention layers configured to perform attention to correlate features between the subset of the set of reference latents and the subset of the set of generated latents.

17. The AI device of claim 12, wherein the controller is further configured to enable the morphable multi-view diffusion model to generate consistent synthetic images regardless of a number of images in the set of reference images based on the stochastic conditioning.

18. The AI device of claim 12, wherein the controller is further configured to train the 4D avatar model based on initializing a plurality of 3D Gaussian primitives of the 4D avatar model by attaching each 3D Gaussian primitive to a specific parent triangle of a parametric mesh derived from the 3DMM parameters.

19. The AI device of claim 18, wherein the controller is further configured to:
remesh the parametric mesh to obtain pixel-aligned vertices in a UV space,
convert expression parameters into a UV map representation, and
utilize a deformation network to predict a UV deformation map based on the UV map representation to correct or augment facial deformations.

20. A non-transitory computer readable medium storing computer-executable instructions that when executed by a processor, cause the processor to perform the operations of:
receiving a set of reference images of a subject, wherein the set of reference images includes one or more images;
encoding the set of reference images into a set of reference latents;
estimating 3D morphable model (3DMM) parameters for the set of reference images;
deriving pose and expression conditioning signals based on the 3DMM parameters;
generating a plurality of synthetic images of the subject from different viewpoints based on the pose and expression conditioning signals using a morphable multi-view diffusion model, wherein the generating the plurality of synthetic images includes:
executing an iterative reverse diffusion process on a set of generated latents,
applying stochastic conditioning during steps of the iterative reverse diffusion process by randomly sampling a subset of the set of reference latents and a subset of the set of generated latents to condition the morphable multi-view diffusion model, and
decoding the set of generated latents to produce the plurality of synthetic images; and
training a 4D avatar model based on the set of reference images and the plurality of synthetic images to generate a trained 4D avatar model, wherein the 4D avatar model utilizes 3D Gaussian splatting augmented with expression dependent appearance model information.
